(19) United States
(12) Patent Application Publication
(10) Pub. No.: US 2009/0190602 A1
(43) Pub. Date: Jul. 30, 2009

(54) METHOD FOR DETECTING GATEWAY IN PRIVATE NETWORK AND APPARATUS FOR EXECUTING THE METHOD

(76) Inventors: Maeng Hee Sung, Seoul (KR); Heejean Kim, Yongin-si (KR); Nam Guk Kim, Seoul (KR); Baeeun Jung, Seongnam-si (KR); Edward Jung, Seongnam-si (KR)

Correspondence Address: MCNEELY BODENDORF LLP, P.O. BOX 34175, WASHINGTON, DC, 20043, US

(21) Appl. No.: 12/190,222

(22) Filed: Aug. 12, 2008

(30) Foreign Application Priority Data
Jan. 28, 2008 (KR) 10-2008-0008782

(51) Int. Cl. H04L 12/56

(52) U.S. Cl. 370/401

(57) ABSTRACT

Disclosed are a method and apparatus for detecting a gateway in a private network. A gateway detection method includes verifying whether a connectable state exists with respect to at least two Internet environments and detecting a driving of a gateway for connection between a private network and an external network in response to verifying the connectable state with respect to the at least two Internet environments.

### CROSS-REFERENCE TO RELATED APPLICATION

This application claims the benefit under 35 U.S.C. § 119(a) of a Korean Patent Application No. 10-2008-0008782, filed on Jan. 28, 2008, in the Korean Intellectual Property Office, the entire disclosure of which is incorporated herein by reference.

### TECHNICAL FIELD

The following description relates to a communication network, and more particularly, to a method for detecting a gateway and an apparatus and/or system using the same.

### BACKGROUND

Along with the development of mobile communication techniques, applications of a handheld device such as a cellular phone, a personal digital assistant (PDA), and the like are increasing. Accordingly, existing wired Internet services are gradually expanded into a wireless Internet environment.

Where a device being connectable with the wireless Internet (referred to as a ‘radio Internet device’) is connected with a private network, the radio Internet device may be exposed to an external network and an outflow of resources of the private network may occur.

For example, where a connection with the private network through the radio Internet device is allowed, security of the private network may be jeopardized due to the device being connectable with a radio Internet using a wireless broadband (WiBro) and the like.

Where the connection with the private network through the radio Internet device is restricted, the connection with the private network may only be established through devices such as a personal computer (PC), a laptop, and the like, which are connectable with the external network only through a single gateway.

Further, where a private device in which at least two network interface cards (NICs) (such as for an Ethernet network, the WiBro, and the like) are enabled is provided in a network, the private device may be readily connected with the external network through the radio Internet device without going through the private gateway.

### SUMMARY

Accordingly, in one general aspect, there is provided a gateway detection method for preventing security of a private network from being jeopardized.

In another general aspect, there is provided a gateway detection method which determines whether a gateway program is installed in a private device being connectable with an external network so as to prevent the private device from being connected with the external network.

In still another general aspect, there is provided a gateway detection method which compares Internet Protocol (IP) packets transmitted/received via a network interface card (NIC) being connectable with different Internet environments so as to determine whether a gateway program is being executed.

In yet another general aspect, a gateway detection method includes verifying whether a connectable state exists with respect to at least two Internet environments and detecting a driving of a gateway for connection between a private network and an external network in response to verifying the connectable state with respect to the at least two Internet environments.

The verifying operation may comprise verifying whether the at least two NICs are in an active state. The at least two NICs may include a first NIC for connection with the private network and a second NIC for connection with the external network.

The detecting operation may comprise determining whether the gateway is driven using an Internet Protocol (IP) packet transmitted/received via the first and second NICs.

The determining of whether the gateway is driven may comprise comparing IP packets included in the first and second NICs, and determining that the gateway is driven in response to an identical IP packet existing in the first and second NICs, respectively.

The comparing of the IP packets may comprise comparing a header and payload of the IP packets to verify whether the IP packets are an identical IP packet.

The comparing of the IP packets may comprise comparing an IP packet transmitted to the second NIC and an IP packet transmitted from the private network to the first NIC while maintaining the IP packet transmitted from the private network to the first NIC for a predetermined time period, in response to detecting the driving of the gateway for connection from the private network to the external network, and comparing an IP packet transmitted to the first NIC and an IP packet transmitted from the external network to the second NIC while maintaining the IP packet transmitted from the external network to the second NIC for a predetermined time period, in response to detecting the driving of the gateway for connection from the external network to the private network.

In response to detecting the driving of the gateway for the connection from the private network to the external network, the comparing may comprise acquiring an IP packet transmitted from a media access control (MAC) layer to a network layer of the first NIC, acquiring an IP packet transmitted from a network layer to a MAC layer of the second NIC after a predetermined time period, and comparing the IP packet acquired from the first NIC and the IP packet acquired from the second NIC, wherein the predetermined time period is a time required for transmitting an IP packet from the network layer of the first NIC to the network layer of the second NIC.

In response to detecting the driving of the gateway for the connection from the external network to the private network, the comparing may comprise acquiring an IP packet transmitted from a MAC layer to a network layer of the second NIC, acquiring an IP packet transmitted from a network layer to a MAC layer of the first NIC after a predetermined time period, and comparing the IP packet acquired from the second NIC and the IP packet acquired from the first NIC, wherein the predetermined time period is a time required for transmitting an IP packet from the network layer of the first NIC to the network layer of the second NIC.

The gateway detection method may further comprise restricting a connection with either the private network or the external network where the gateway is detected as being driven.

In yet another general aspect, a gateway detection apparatus includes a state verification unit which verifies whether a connectable state exists with respect to at least two Internet environments and a gateway detection unit which detects a driving of a gateway for connection between a private network and an external network in response to verifying the connectable state with respect to the at least two Internet environments.

The state verification unit may include an NIC verification unit which verifies whether a first NIC for connection with the private network and a second NIC for connection with the external network are in an active state.

The gateway detection unit may include an IP acquisition unit which acquires IP packets transmitted/received via a Transmission Control Protocol/Internet Protocol (TCP/IP) stack of the first NIC and a TCP/IP stack of the second NIC, respectively, and an IP comparison unit which compares the IP packet acquired from the first NIC and the IP packet acquired from the second NIC.

The IP comparison unit may determine that the gateway is driven where an identical IP packet exists in the first and second NICs, respectively.

The IP acquisition unit may acquire an IP packet transmitted from a MAC layer to a network layer of the first NIC, and acquire an IP packet transmitted from a network layer to a MAC layer of the second NIC where a connection from the private network to the external network is performed.

The IP acquisition unit may acquire an IP packet transmitted from a MAC layer to a network layer of the second NIC, and acquire an IP packet transmitted from a network layer to a MAC layer of the first NIC where a connection from the external network to the private network is performed.

The IP comparison unit may compare a header and payload of the respective IP packets of the first and second NICs.

The IP comparison unit may determine that the gateway is driven where an identical IP packet exists in the first and second NICs.

The gateway detection unit may further include a connection control unit which restricts a connection with either the private network or the external network where the gateway is detected as being driven.

Other features will become apparent to those skilled in the art from the following detailed description, which, taken in conjunction with the attached drawings, discloses exemplary embodiments of the invention.

### BRIEF DESCRIPTION OF THE DRAWINGS

FIG. 1 is a schematic diagram illustrating a method for detecting a driving of a gateway in a private network according to an exemplary embodiment.

FIG. 2 is a flowchart illustrating a method for detecting a driving of a gateway according to an exemplary embodiment.

FIG. 3 is a flowchart illustrating a process for driving a gateway where a connection from a private network to an external network is allowed according to an exemplary embodiment.

FIG. 4 is a block diagram illustrating an exemplary configuration of a data packet generated in a device within a private network according to an exemplary embodiment.

FIG. 5 is a block diagram illustrating a process for transmitting a data packet through a device in which at least two network interface cards (NICs) are activated according to an exemplary embodiment

FIG. 6 is a block diagram illustrating an exemplary configuration of an Internet Protocol (IP) packet transmitted between a Media Access Control (MAC) layer and a network layer of an NIC according to an exemplary embodiment.

FIG. 7 is a block diagram illustrating an exemplary configuration of a data packet for data transmission from a private network to an external network according to an exemplary embodiment.

FIG. 8 is a flowchart illustrating a gateway detection process for restricting connection from a private network to an external network according to an exemplary embodiment.

FIG. 9 is a block diagram illustrating an internal configuration of a gateway detection apparatus of a private network according to an exemplary embodiment.

Throughout the drawings and the detailed description, unless otherwise described, the same drawing reference numerals will be understood to refer to the same elements, features, and structures. The elements may be exaggerated for clarity and convenience.

### DETAILED DESCRIPTION

The following detailed description is provided to assist the reader in gaining a comprehensive understanding of the media, apparatuses, methods and/or systems described herein. Accordingly, various changes, modifications, and equivalents of the systems, methods, apparatuses and/or media described herein will be suggested to those of ordinary skill in the art. Also, description of well-known functions and constructions are omitted to increase clarity and conciseness.

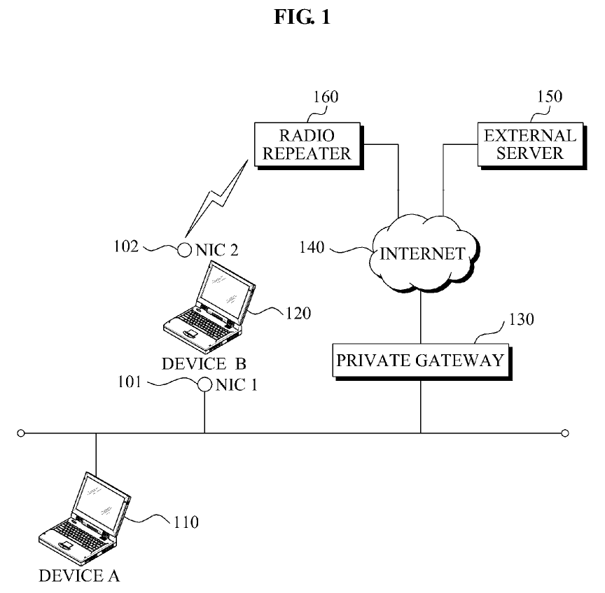

FIG. 1 illustrates construction of an exemplary private network system and an exemplary method for detecting a driving of a gateway in a private network. According to an aspect, FIG. 1 illustrates an exemplary method for detecting a driving of an external gateway, such that private devices 110 and 120 within a private network are connected with an external server 150 only through a private gateway 130 when being connected with the external server 150 via the Internet 140.

A private network system according to an exemplary embodiment may verify whether the external gateway is driven in the private devices 110 and 120, and be applicable to a wired/wireless network system forming a private network. In order to detect the driving of the external gateway in the private network system, where the private gateway 130 is connected with the private devices 110 and 120, the private devices 110 and 120 may include a predetermined program capable of verifying whether the external gateway is driven. Also, a predetermined program module may be connectively configured within the private network, and the external gateway of the private devices 110 and 120 may be detected using the predetermined program module.

The private devices 110 and 120 may include a network interface card (NIC) for connection with the private network. Referring to FIG. 1, where the private device 120 (device B) capable of being connected with the external network is present in the private network, the private device B 120 includes an NIC 101 (NIC 1) for connection with the private network, and an NIC 102 (NIC 2) for connection with the external network. In this case, the external network may denote a radio Internet, and the private device B 120 may denote a radio Internet device capable of radio Internet connection. Where the radio Internet device is allowed to be connected with the private network, the radio Internet device may be connected with the external server 150 via a radio repeater 160 without passing through the private gateway 130.

A private network system according to an exemplary embodiment detects the external gateway, so that the private device B 120 capable of being connected with the private network and the external network, for example, a radio Internet, may be connected with the Internet 140 only through the private gateway 130.

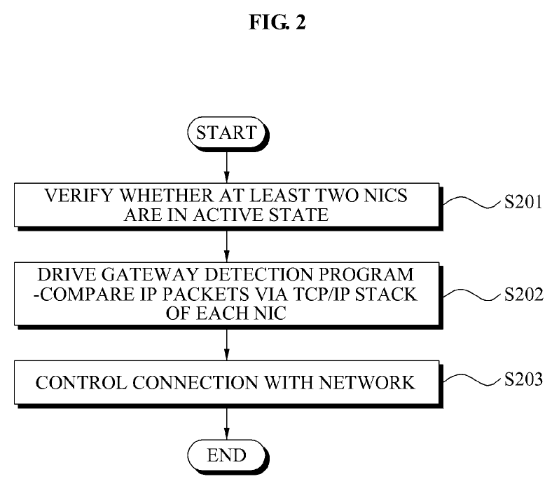

FIG. 2 illustrates an exemplary method for detecting a driving of a gateway of a private network.

In operation S201, a private network system verifies whether at least two NICs are activated in a private device. The private network system verifies whether the private device is in a state of being connectable with at least two Internet environments, that is, in a state of being connectable with an external network other than a private network. The private network system may verify whether an NIC for connection with the private network of the private device (hereinafter, referred to as ‘a first NIC’) and an NIC for connection with the external network (hereinafter, referred to as ‘a second NIC’) are in an active state.

In operation S202, the private network system executes a gateway detection program for detecting the driving of the external gateway where the first and second NICs of the private device are in the active state. The private network system may compare Internet protocol (IP) packets transmitted/received via a Transmission Control Protocol/Internet Protocol (TCP/IP) stack of the first and second NICs. The private network system may ascertain that the external gateway is driven in the private device where an identical IP packet is present in the TCP/IP stack of the first and second NICs, respectively.

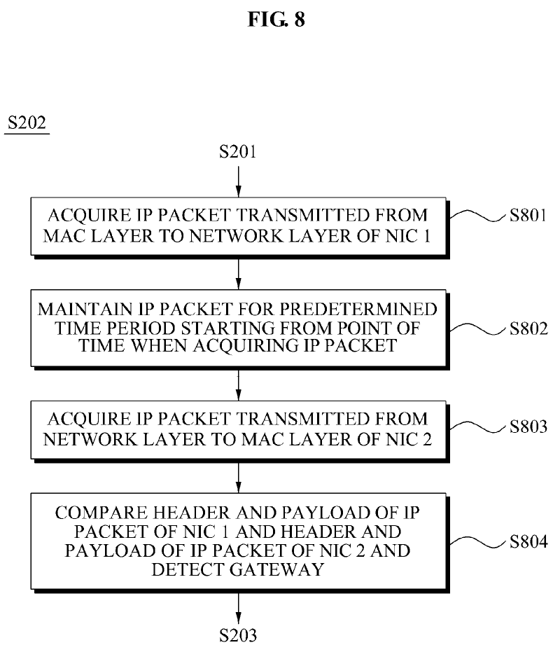

The operation S202 for detecting the external gateway using the IP packets transmitted/received via the first and second NIC will be described in detail with reference to FIG. 8.

In operation S203, the private network system controls network connection of the private device where the identical IP packet is present in the TCP/IP stack of the first and second NICs, respectively. The private network system may restrict either the connection with the external network where a connection from the private network to the external network is established, or the connection with the private network where a connection from the external network to the private network is established.

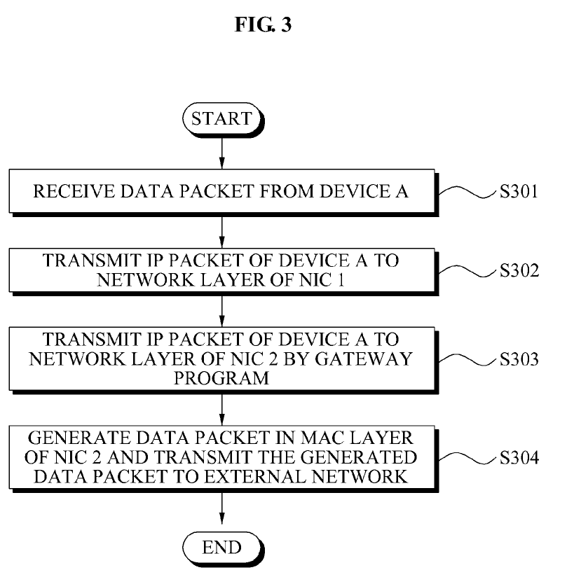

FIG. 3 illustrates an exemplary process for driving a gateway where a connection from a private network to an external network is allowed. FIG. 3 illustrates an example of a process where the private device A 110 as illustrated in FIG. 1 is connected with the external network through the private device B 120.

In operation S301, the private device B 120 receives a data packet intended to be transmitted from the private device A 110 to the external network.

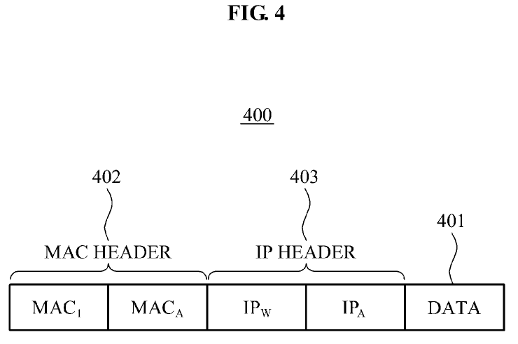

FIG. 4 illustrates a configuration of a data packet 400 generated in a device within a private network according to an exemplary embodiment. Referring to FIGS. 1 and 4, the private device A 110 generates the data packet 400 having a MAC header 402, that is, a hardware address of a private network frame, and an IP header 403, that is, an address of the private device A 110, along with data 401 intended to be transmitted by the private device A 110, and transmits the generated data packet 400 to the private device B 120. The MAC header 402 may comprise a MAC address MAC₁ corresponding to the NIC 1 of the private device B 120 connected with the private network and a MAC address MAC_{A} of the private device A 110, and the IP header 403 may comprise an IP address IP_{W} of the external server 150 intended to be connected and an IP address IP_{A} of the private device A 110.

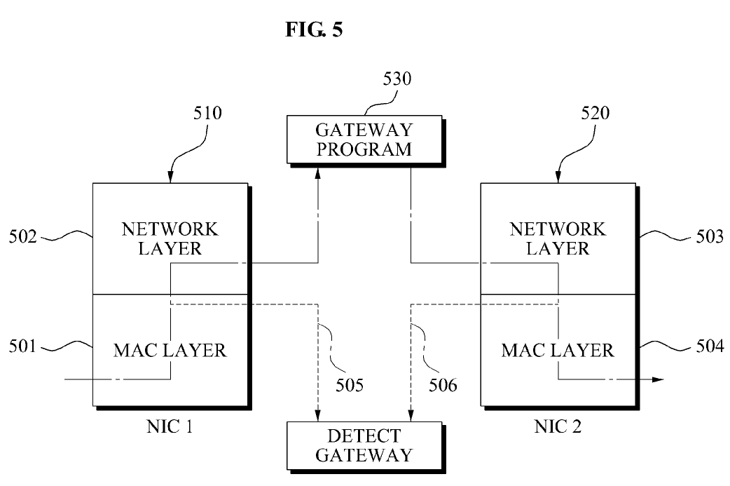

Returning to FIG. 3, gateway driving operations following the operation S301 will be described with reference to FIGS. 1 and 5. FIG. 5 illustrates an exemplary process for transmitting a data packet through the private device B 120.

In operation S302, the private device B 120 verifies whether a data packet received from the private device A 110 is a packet transmitted to the private device B 120 using the MAC address within the data packet received from the private device A 110, and then transmit an IP packet of the private device A 110 from a MAC layer 501 to a network layer 502 of an NIC1 510.

In operation S303, the private device B 120 transmits the IP packet of the private device A 110 to a network layer 503 of an NIC2 520, according to activation of the NIC2 520, using a gateway program 530 installed to connect with the external network.

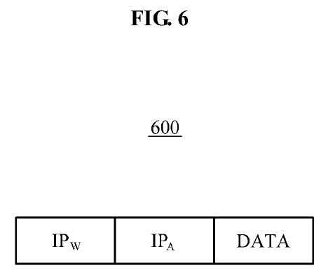

FIG. 6 illustrates an exemplary IP packet 600 of the private device A 110 transmitted between the NIC1 510 and the NIC2 520. The IP packet 600 comprises data and an IP header having an IP address IP_{W} of the external server 150 intended to be connected and an IP address IP_{A} of the private device A 110.

In operation S304, the private device B 120 transmits the IP packet of the private device A 110 from the network layer 503 to a MAC layer 504 of the NIC2 520. Here, a data packet is generated with respect to the IP packet of the private device A 110 in the MAC layer 504 of the NIC2 520, and the generated data packet is transmitted to the external network.

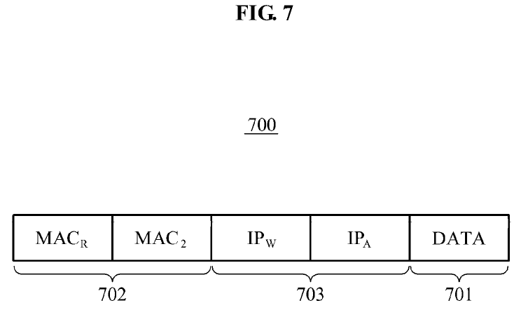

FIG. 7 illustrates a configuration of a data packet 700 for data transmission from a private network to an external network according to an exemplary embodiment. Referring to FIGS. 1, 5 and 7, the data packet generated in the MAC layer 504 of the private device B 120 includes data 701 desired to be transmitted by the private device A 110, a MAC header 702 and an IP header 703 for connection with the external network. The MAC header 702 includes an MAC address MAC_{R} of a repeater (e.g., may denote a radio repeater in the case of being connected with a radio Internet) with respect to the external network and an MAC address MAC₂ corresponding to the NIC2 of the private device B 120, and the IP header 703 includes an IP address IP_{W} of the external server 150 and an IP address IP_{A} of the private device A 120.

The connection from the private network to the external network or the connection from the external network to the private network may be established using a device in which an NIC connectable with the private network and an NIC connectable with the external network are activated.

An exemplary gateway detection method may detect the external gateway using an IP packet transmitted/received via different NICs in the process for driving the gateway as described in FIG. 3, and may restrict the connection of the private device and the network where the external gateway is detected.

FIG. 8 illustrates a gateway detection process which restricts connection from a private network to an external network according to an exemplary embodiment. FIG. 8 further illustrates the operation S202 of FIG. 2 for detecting the external gateway. The operations of FIG. 8 will be described with reference to FIG. 2 and the process for transmitting the data packet as described with reference to FIG. 5.

In operation S801, the private network system acquires an IP packet 505 transmitted from the MAC layer 501 to the network layer 502 of the NIC1 510. The private network system may monitor a moment of transmitting the IP packet from the MAC layer 501 to the network layer 502 at the time of transmission of the IP packet between layers within the NIC1 510 to acquire the corresponding IP packet 505.

In operation S802, the private network system maintains the IP packet 505 for a predetermined time period from a time when acquiring the IP packet 505 in the NIC1 510. The predetermined time period for maintaining the IP packet 505 may denote a time required for transmitting the IP packet 505 from the network layer 502 of the NIC1 510 to the network layer 503 of the NIC2 520.

In operation S803, the private network system acquires an IP packet 506 transmitted from the network layer 503 to MAC layer 504 of the NIC2 520. The private network system may monitor a moment of transmitting the IP packet from the network layer 503 to the MAC layer 504 to thereby acquire the corresponding IP packet 506.

In operation S804, the private network system compares the IP packet 505 acquired in the NIC1 510 and the IP packet 506 acquired in the NIC2 520, and detects the driving of the gateway for connection with the external network. The private network system may compare a header and payload of the IP packets, so that whether the IP packet 505 acquired in the NIC1 510 and the IP packet 506 acquired in the NIC2 520 are an identical IP packet may be determined.

Where the identical IP packet is present in the NIC1 510 and the NIC2 520, respectively, the private network system may determine that the external gateway program is driven, and restrict the connection with the network.

Also, the gateway detection process for restricting the connection from the external network to the private network may be performed similar to the method described in FIG. 8, such that the driving of the external gateway may be detected by acquiring IP packets from different NICs and comparing the acquired IP packets. Where the connection from the external network to the private network is detected, the data packet received from the external network is transmitted to the private network after passing through a path from the NIC2 520 to the NIC1 510, and thus acquiring the IP packet 506 transmitted from the MAC layer 504 to network layer 503 of the NIC2 520, and then acquiring the IP packet 505 transmitted from the network layer 502 to MAC layer 501 of the NIC1 510.

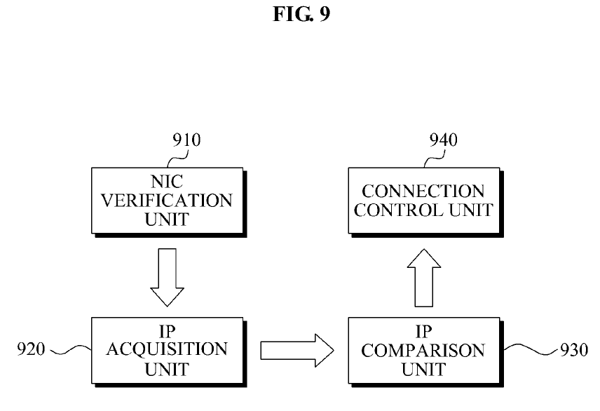

FIG. 9 illustrates a configuration of a gateway detection apparatus, for example, of a private network, according to an exemplary embodiment. The gateway detection apparatus includes an NIC verification unit 910, an IP acquisition unit 920, an IP comparison unit 930, and a connection control unit 940.

The NIC verification unit 910 may be configured to verify whether at least two NICs are activated in a private device, and more particularly, may function to verify whether a first NIC for connection with a private network and a second NIC for connection with an external network are in an active state.

The IP acquisition unit 920 may acquire IP packets transmitted/received via a TCP/IP stack of the first NIC and a TCP/IP stack of the second NIC, respectively, where the first and second NICs of the private network are activated.

Where the connection from the private network to the external network is detected, the IP acquisition unit 920 may acquire an IP packet transmitted from a MAC layer to a network layer of the first NIC, and acquire an IP packet transmitted from a network layer to a MAC layer of the second NIC. Also, where the connection from the external network to the private network is established, the IP acquisition unit 920 may acquire an IP packet transmitted from the MAC layer to the network layer of the second NIC, and acquire an IP packet transmitted from the network layer to the MAC layer of the first NIC.

The IP comparison unit 930 may function to compare the IP packets acquired from the first and second NICs, respectively. That is, the IP comparison unit 930 may compare a header and payload of the IP packets to determine whether they are an identical IP packet. The IP comparison unit 930 may determine that the gateway for the connection with the external network is driven where the identical IP packet is present in the first and second NICs, respectively.

Where the external gateway is determined to be driven, the connection control unit 940 may restrict the connection with the private network of the private device or with the external network.

The exemplary gateway detection apparatus may be configured either separately from the private network, or to be included in the private device.

A gateway detection method according to an exemplary embodiment may compare IP packets existing in different NICs where at least two NICs are activated in a private device, and detect whether an external gateway is driven, thereby restricting access from a private network to the external network or access from the external network to the private network. The exemplary gateway detection method may be connectable with the external network even without passing through the private gateway in a state where the NIC connected with the private network is not activated, so as to provide convenience to a user using the external network such as a radio Internet, while also protecting the private network.

The methods described above including a gateway detection method may be recorded, or fixed in one or more computer-readable media that includes program instructions to be implemented by a computer to cause a processor to execute or perform the program instructions. The media may also include, independent or in combination with the program instructions, data files, data structures, and the like. The media and program instructions may be those specially designed and constructed for the purposes of the present invention, or they may be of the kind well-known and available to those having skill in the computer software arts. Examples of computer-readable media may include magnetic media such as hard disks, floppy disks, and magnetic tape; optical media such as CD ROM disks and DVD; magneto-optical media such as optical disks; and hardware devices that are specially configured to store and perform program instructions, such as read-only memory (ROM), random access memory (RAM), flash memory, and the like. Examples of program instructions include both machine code, such as produced by a compiler, and files containing higher level code that may be executed by the computer using an interpreter. The described hardware devices may be configured to act as one or more software modules in order to perform the operations and/or methods described above.

A number of exemplary embodiments have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. A gateway detection method, comprising:
verifying whether a connectable state exists with respect to at least two Internet environments; and
detecting a driving of a gateway for connection between a private network and an external network in response to verifying the connectable state with respect to the at least two Internet environments.

2. The method of claim 1, wherein:
the verifying comprises verifying whether at least two network interface cards (NICs) are in an active state, and
the at least two NICs comprises a first NIC for connection with the private network and a second NIC for connection with the external network.

3. The method of claim 2, wherein the detecting of the driving of the gateway comprises determining whether the gateway is driven using an Internet Protocol (IP) packet transmitted/received via the first and second NICs.

4. The method of claim 3, wherein the determining of whether the gateway is driven comprises:
comparing IP packets included in the first and second NICs; and
determining that the gateway is driven in response to an identical IP packet existing in the first and second NICs, respectively.

5. The method of claim 4, wherein the comparing of the IP packets comprises comparing a header and payload of the IP packets.

6. The method of claim 4, wherein the comparing of the IP packets comprises:
comparing an IP packet transmitted to the second NIC and an IP packet transmitted from the private network to the first NIC while maintaining the IP packet transmitted from the private network to the first NIC for a predetermined time period, in response to detecting the driving of the gateway for connection from the private network to the external network, and
comparing an IP packet transmitted to the first NIC and an IP packet transmitted from the external network to the second NIC while maintaining the IP packet transmitted from the external network to the second NIC for a predetermined time period, in response to detecting the driving of the gateway for connection from the external network to the private network.

7. The method of claim 6, wherein in response to detecting the driving of the gateway for the connection from the private network to the external network, the comparing comprises:
acquiring an IP packet transmitted from a media access control (MAC) layer to a network layer of the first NIC;
acquiring an IP packet transmitted from a network layer to a MAC layer of the second NIC after a predetermined time period; and
comparing the IP packet acquired from the first NIC and the IP packet acquired from the second NIC,
wherein the predetermined time period is a time required for transmitting an IP packet from the network layer of the first NIC to the network layer of the second NIC.

8. The method of claim 6, wherein in response to detecting the driving of the gateway for the connection from the external network to the private network, the comparing comprises:
acquiring an IP packet transmitted from a MAC layer to a network layer of the second NIC;
acquiring an IP packet transmitted from a network layer to a MAC layer of the first NIC after a predetermined time period; and
comparing the IP packet acquired from the second NIC and the IP packet acquired from the first NIC,
wherein the predetermined time period is a time required for transmitting an IP packet from the network layer of the first NIC to the network layer of the second NIC.

9. The method of claim 1, further comprising
restricting a connection with either the private network or the external network where the gateway is detected as being driven.

10. A computer-readable recording medium storing a program to implement a gateway detection method, the program comprising instructions to case a computer to:
verify whether a connectable state exists with respect to at least two Internet environments; and
detect a driving of a gateway for connection between a private network and an external network in response to verifying the connectable state with the at least two Internet environments.

11. The computer-readable recording medium of claim 10, wherein:
the verifying comprises verifying whether at least two network interface cards (NICs) are in an active state, and
the at least two NICs comprises a first NIC for connection with the private network and a second NIC for connection with the external network.

12. The computer-readable recording medium of claim 11, wherein:
the detecting of the driving of the gateway comprises determining whether the gateway is driven using an Internet Protocol (IP) packet transmitted/received via the first and second NICs, and
the program further comprises an instruction to cause the computer to restrict a connection with either the private network or the external network where the gateway is detected as being driven.

13. A gateway detection apparatus, comprising:
a state verification unit which verifies whether a connectable state exists with respect to at least two Internet environments; and
a gateway detection unit which detects a driving of a gateway for connection between a private network and an external network in response to verifying the connectable state with respect to the at least two Internet environments.

14. The apparatus of claim 13, wherein the state verification unit comprises a network interface card (NIC) verification unit which verifies whether a first NIC for connection with the private network and a second NIC for connection with the external network are in an active state.

15. The apparatus of claim 14, wherein the gateway detection unit detects the driving of the gateway by comparing Internet Protocol (IP) packets included the first and second NICs.

16. The apparatus of claim 15, wherein the gateway detection unit comprises:
an IP acquisition unit which acquires IP packets transmitted/received via a Transmission Control Protocol/Internet Protocol (TCP/IP) stack of the first NIC and a TCP/IP stack of the second NIC, respectively; and
an IP comparison unit which compares the IP packet acquired from the first NIC and the IP packet acquired from the second NIC.

17. The apparatus of claim 16, wherein:
where a connection from the private network to the external network is performed, the IP acquisition unit acquires an IP packet transmitted from a MAC layer to a network layer of the first NIC, and acquires an IP packet transmitted from a network layer to a MAC layer of the second NIC, and
where a connection from the external network to the private network is performed, the IP acquisition unit acquires an IP packet transmitted from a MAC layer to a network layer of the second NIC, and acquires an IP packet transmitted from a network layer to a MAC layer of the first NIC.

18. The apparatus of claim 16, wherein the IP comparison unit compares a header and payload of the respective IP packets of the first and second NICs.

19. The apparatus of claim 16, wherein the IP comparison unit determines that the gateway is driven where an identical IP packet exists in the first and second NICs.

20. The apparatus of claim 16, wherein the gateway detection unit further comprises a connection control unit which restricts a connection with either the private network or the external network where the gateway is detected as being driven.
